(19) United States
(12) Patent Application Publication
(10) Pub. No.: US 2020/0372793 A1
(43) Pub. Date: Nov. 26, 2020

(54) Method, Device, and System of Dynamic Allocation of Traffic Resources

(71) Applicant: Axilion Ltd., Haifa (IL)

(72) Inventor: Ilan Weizman, Haifa (IL)

(21) Appl. No.: 16/957,726

(22) PCT Filed: Dec. 26, 2018
(86) PCT No.: PCT/IL2018/051389

§ 371 Date: Jun. 25, 2020

Related U.S. Application Data
(60) Provisional application No. 62/612,446, filed on Dec. 31, 2017.

(51) Int. Cl. G08G 1/01; G08G 1/056; G08G 1/04; G08G 1/08; G08G 1/095; G08G 1/02; G08G 1/015

(52) U.S. Cl. CPC G08G 1/0145; G08G 1/0116; G08G 1/056; G08G 1/0112; G08G 1/015; G08G 1/08; G08G 1/095; G08G 1/02; G08G 1/04

(57) ABSTRACT

Method, device, and system of dynamic allocation of traffic resources. A method includes: receiving indications of characteristics of vehicles that are approaching to a particular intersection; based on the characteristics, determining a priority score for each vehicle of those vehicles; determining an aggregated priority score for each arm of that particular intersection; based on the aggregated priority score determined for each arm of that particular intersection, dynamically determining a green-light period to be allocated by a traffic light of that particular intersection, and commanding the traffic light to deploy that green-light period.

### CROSS-REFERENCE TO RELATED APPLICATIONS

This patent application claims priority and benefit from U.S. patent application Ser. No. 62/612,446, filed on Dec. 31, 2017, which is hereby incorporated by reference in its entirety.

### FIELD

The present invention is related to vehicular traffic control.

### BACKGROUND

Millions of people utilize cars, vans, trucks, buses, taxis, and various other types of vehicle, in order to travel or to reach a desired destination. Various route segments, such as a road, a street, an avenue, or a boulevard, connect various parts of a town or city.

An intersection is where two or more roads meet or cross. The vehicular traffic in or near some intersections is controlled via traffic signs, for example, a Stop sign or a Yield sign. In some intersections, particularly those that connect busy or high-traffic roads, a traffic light mechanism is utilized to organize the traffic; for example, displaying a red light to vehicles that are commanded to stop, and displaying a green light to vehicles that are commanded to go.

### SUMMARY

The present invention may include, for example, systems, devices, and methods for dynamic allocation of traffic resources.

In some embodiments, a traffic light system is controlled or regulated to dynamically allocate the time-slots of red light and green light, to the intersecting road segments, based on a ranking system or a point-based system that takes into account one or more parameters or features of the vehicles that occupy each one of the intersecting road segments, and/or based on characteristics or features of other road-users or entities (e.g., pedestrians, bicycle riders, scooter riders, or the like). For example, a road segment may be allocated points based on the type of vehicle(s) that currently occupy it (e.g., bus, school-bus, truck, sedan car), and/or based on the pollution or carbon-footprint that is emitted or generated by the vehicle(s) that currently occupy it, and/or based on the number of passengers or occupants that actually occupy the vehicle(s), and/or based on other pre-defined criteria or conditions (e.g., Hazardous Material (Haz-Mat) vehicle, a snow plow vehicle, first responder or emergency vehicle). The green light is allocated in a dynamic or adaptive manner to different road segments in view of their current ranking or aggregate number of points.

The present invention may provide other and/or additional benefits or advantages.

### BRIEF DESCRIPTION OF THE DRAWINGS

FIG. 1 is a schematic illustration of a traffic system, in accordance with some demonstrative embodiments of the present invention.

FIG. 2 is a schematic illustration of another traffic system, in accordance with some demonstrative embodiments of the present invention.

### DETAILED DESCRIPTION OF THE PRESENT INVENTION

The Applicants have realized that a conventional traffic light system may operate inefficiently in some situations; particularly when it allocates a fixed time-slot or even traffic actuated (with predetermined green extension period) signals of green-light signal to a road in a manner that disregards the current actual occupancy of that road and/or of other roads that arrive to the same intersection.

The Applicants have realized that a conventional traffic light system, at a demonstrative intersection of Third Street and Fifth Avenue, is pre-programmed to allocate 32 seconds of green-light to Fifth Avenue traffic (while Third Street traffic gets a red-light signal), then 36 seconds of green-light to Third Street traffic (while Fifth Avenue traffic gets a red-light signal), then again 32 seconds of green-light to Fifth Avenue traffic (while Third Street traffic gets a red-light signal), and so forth. Optionally, a clearance time-period of about two or three seconds, may be allocated between a first arm turning from green light to red light and a second arm turning from red light to green light, in order to enable vehicles to clear the intersection.

The Applicants have realized that such fixed allocation may be inefficient. For example, Third Street may have only one car approaching the intersection, whereas Fifth Avenue may have 24 cars approaching the intersection; and therefore the allocation of generally-similar green-light time periods (32 seconds, 36 seconds) may lead to inefficient traffic flow, as only 16 of the 24 cars on Fifth Avenue would manage to cross the intersection during its allocated green-light time-slot, and the remaining 8 cars of Fifth Avenue would wait for an additional cycle which is wasted on a single car driving on Third Street.

The Applicants have further realized that the solution to the problem is not merely in counting the number cars that approach the intersection; but rather, the solution may utilize other parameters, features, and conditions in order to achieve efficient distribution of traffic resources and particularly the efficient allocation of green-light signal at an intersection. For example, a public transportation bus that currently transports 54 people inside it, may count as a single vehicle on Third Street; and if the allocation system counts only vehicles, then the single bus on Third Avenue is indeed a smaller number relative to the three sedan cars on Fifth Avenue, each car occupied by a single person; however, the 54 travelers inside the single bus on Third Street, are 18 times the total number of travelers in the three cars on Fifth Avenue. Therefore, a mere counting of the vehicles may still not yield an optimal or improved allocation of resources, and other parameters should be taken into consideration in order to improve the allocation of resources.

The present invention may utilize one or more methods for detecting and/or classifying vehicles that are approaching the intersection (e.g., are within N meters from the intersection; and/or are expected to reach the intersection within T seconds), as well as for detecting one or more features or properties of those vehicles and/or of their occupants, e.g., number of occupants; type of vehicle; pollution/emission levels of the vehicle; purpose of the trip of the vehicle; type of cargo or goods that are transported within the vehicle; characteristics of occupants of the vehicle (e.g., young students in a school-bus; general population in a public transportation bus; sick person in an ambulance).

The information may be captured by, obtained from or collected by one or more local sensors or local detectors or local measuring units which may be directly connected (e.g., via a local wire or cable) to a local Traffic Light Controller (TLC) whose resources are being regulated or modified; such sensors or detectors may comprise, for example, a camera able to capture images and/or video and/or audio, a microphone, a thermal camera, an electro-magnetic loop or magnetic wire, a pressure-sensitive loop or wire, one or more wireless receivers or transceivers (e.g., Wi-Fi, Bluetooth, DSRC, C-V2X, cellular 2G, cellular 3G, cellular 4G, cellular 4G LTE, cellular 5G, V2V elements, V21 elements, V2X elements, P21 elements, or the like.

In some embodiments, additionally or alternatively, the information may be captured by, obtained from or collected by one or more remote sensors or detectors, which are not directly connected via a wire or a cable to a local TLC being regulated, but rather, are located away from the particular TLC being regulated (e.g., located at least 20 or 50 or 700 or M meters away from the TLC) and communicate with the TLC via one-way or two-way communication over a suitable communication medium or signal propagation medium (e.g., wire, cable, copper, fiber, fiber-optic, cellular connection, Wi-Fi connection, wireless connection, microwave transmissions, or the like). Some embodiments may utilize a combination or fusion of multiple types of local and/or remote detectors or sensors, as well as fusion of the information obtained from them.

Some embodiments of the present invention may further obtain and/or receive and/or utilize data about approaching vehicles, and their characteristics (type, number of passengers, or the like) from other third-party sources, for example, fleet management systems, traffic information obtained from Google Maps or from Waze or other mapping systems or navigation systems, information from ride-sharing or car-hailing systems (e.g., systems of Uber, Lyft, or the like), data from dispatching systems (e.g., of taxis, of limousines, of buses, or the like), data from Computer-Aided Dispatch/Automatic Vehicle Location (CAD/AVL) systems, and/or from other sources; and such information may further be fused with other data, and/or may be taken into account in order to determine dynamic allocation of green-light or other traffic resources.

In accordance with some demonstrative embodiments of the present invention, a Vehicle Ranking or a Road-Segment Ranking sub-system is utilized, in order to rank, or to allocate points or numerical values to, one or more vehicles that are approaching the intersection or the TLC, and/or one or more road-segments or “arms” of the intersection, for example by utilizing a weighted function or formula that further allocates a weight to each sensed parameter or data-item. It is noted that the following description is a non-limiting example, and that other ranking values or criteria may be used, and may be defined by a suitable lookup table, database, data array, one or more pre-defined conditions (e.g., if condition C holds true then allocate ranking of P points to vehicle V or to road-segment R), and/or a suitable combination thereof.

In a demonstrative example, a first criterion for ranking of vehicles that approach the intersection or the TLC is based on the Type of the approaching vehicle. For example, Lookup Table 1 may be used to allocate a numerical value or a point value, to each approaching vehicle based on its type, as follows:

LOOKUP TABLE 1

| Vehicle Type | Priority Points Allocated |
|---|---|
| Sedan car | 2 |
| Public Transportation Bus | 6 |
| Yellow School-Bus | 7.5 |
| Privately-Hired Driver | 3 |
| (taxi, limousine, Uber) | |
| Shared Vehicle/Carpool Vehicle | 4.25 |
| Emergency Vehicle | 8 |
| (Ambulance, Police) | |
| Van | 4 |
| Truck, Semi-Trailer, 18-wheeler | 5.5 |
| Motorcycle | 3 |
| Bicycle | 2 |
| Pedestrian (no vehicle) | 1 |

Additionally or alternatively, a second criterion for ranking of vehicles that approach the intersection or the TLC is based on the estimated or known emission/pollution that is generated by the vehicle.

For example, in a first set of embodiments, a lower level of emission/pollution may be associated with a greater number of priority points allocated, in order to provide an incentive to drivers to gradually switch from more-polluting cars to less-polluting cars (or from high-emission cars to low-emission or zero-emission cars).

In the first set of embodiments mentioned above, Lookup Table 2A may be used:

LOOKUP TABLE 2A

| Vehicle Emissions/Pollution Type | Priority Points Allocated |
|---|---|
| Diesel-based Vehicle | 1 |
| Gasoline-based Vehicle | 2.5 |
| Partial Zero Emissions Vehicle (PZEV) | 3.5 |
| Hybrid Gasoline-and-Electric Vehicle | 4 |
| Electric-Only Vehicle | 5 |
| Bicycle (without motor) | 7 |
| Pedestrian (no vehicle) | 7.5 |

In a second set of embodiments, an opposite consideration may be used, and a higher level of emission/pollution may be associated with a greater number of priority points allocated, in order to avoid a situation in which a highly-polluting vehicle remains stuck in the intersection waiting for the green-light for a prolonged time and polluting his surrounding, and/or in order to shorten the amount of time that such polluting vehicle spends on the road.

In the first set of embodiments mentioned above, Lookup Table 2B may be used:

LOOKUP TABLE 2B

| Vehicle Emissions/Pollution Type | Priority Points Allocated |
|---|---|
| Diesel-based Vehicle | 8 |
| Gasoline-based Vehicle | 6.5 |
| Hybrid Gasoline-and-Electric Vehicle | 4 |
| Partial Zero Emissions Vehicle (PZEV) | 3.5 |
| Electric-Only Vehicle | 3 |
| Bicycle (without motor) | 2.25 |
| Pedestrian (no vehicle) | 1 |

Additionally or alternatively, a third criterion for ranking of vehicles that approach the intersection or the TLC is based on the estimated or known number of occupants of each vehicle. In a first example, each occupant contributes exactly one point, or exactly P points (e.g., P equals 1.25, or 2.0, or other fixed value) to the aggregate priority points of the vehicle. In a second example, the priority points of a vehicle having N passengers is set by a numerical formula; for example, it may equal to 3+2 N. In a third example, a lookup table such as Lookup Table 3 may be used to allocate priority point based on this criterion, utilizing particular discrete values or ranges-of-values, for example

LOOKUP TABLE 3

| Number of Occupants in Vehicle | Priority Points Allocated |
|---|---|
| 1 | 1 |
| 2 | 2.25 |
| 3 or 4 | 3.5 |
| 5 or 6 or 7 | 5.75 |
| 8 or 9 o 10 | 6 |
| 11 to 18 | 7.5 |
| 19 or more | 9 |

Additionally or alternatively, a fourth criterion for ranking of vehicles that approach the intersection or the TLC is based on the identification of one or more other estimated or known features of the approaching vehicle and/or its trip purpose and/or its cargo and/or its occupants. For example, Lookup Table 4 may be used:

LOOKUP TABLE 4

| Special Feature of the Vehicle, | Priority Points |
|---|---|
| Or Other Data Known About the Vehicle | Allocated |
| Consular Vehicle | 2 |
| Hazardous Material (Haz-Mat) | 4 |
| Government Official | 3.7 |
| Public Transportation Running Late (behind schedule) | 8 |
| Public Transportation ahead of its schedule | 0 |
| Public Transportation Vehicle with 100% occupancy | 9.5 |
| Public Transportation Vehicle with <20% occupancy | 2.5 |

In accordance with the present invention, a Vehicular Score is calculated for each vehicle that is approaching the intersection or the TLC. In a first example, the priority points of each vehicle are summed or accumulated, based on the vehicle's respective record in each lookup table (if at all the vehicle has a respective record). For example, an electric sedan car that approaches the intersection and has four occupants would accumulate: 2 priority points from Lookup Table 1 (for being a “sedan”), plus 5 priority points from Lookup Table 2A (for being an “electric-only” car), plus 3.5 priority points from Lookup Table 3 (for having “3 or 4 occupants”), plus zero additional priority points from Lookup Table 4 (due to lack of any additional special feature), totaling 10.5 priority points for that vehicle. Similarly, the same car in which a Consular member is driven (e.g., having a Consular license plate), would accumulate 2 additional priority points and would reach a total of 12.5 priority points.

In a second example, instead of mere summation, a weighted formula is utilized to allocate different weights to each one of the four criteria. For example, the priority points that originate from each Lookup Table, are first multiplied by a particular factor or coefficient or weight-factor for that lookup table; and then, the products are summed or accumulated. For example, lookup table 1 may be associated with a multiplication factor of 2.5; whereas lookup table 4 may be associated with a multiplication factor of 0.8; and so forth. The utilization of such factors or coefficient may enable, for example, flexible adaptation or modification of the system; for example, enabling the system to efficiently put on hold, and disregard, the Special Feature priority points for a pre-defined time period (e.g., for the next 45 minutes, during “rush hour”), by allocating a weight-factor of zero to the values pulled from Lookup Table 4. Similarly, during Earth Day or Clean Energy Day, the system may be configured to allocate increased weight to the values pulled from Lookup Table 2A, by modification (e.g., increase) of the multiplication factor of that lookup table.

In a third example, a particular function or formula may be used, taking into account some or all of the criteria that generate priority points per vehicle. For example, the weighted priority score of a vehicle, may be a function F that uses, as parameters, the priority points related to vehicle type, the priority points related to emissions/pollution level, the priority points related to number of occupants, and/or the priority points related to other special features. The total priority score may be within a pre-defined range of scores, such as in the range of 0 to 100.

The present invention may then determine an aggregated priority score for a group of vehicles, and particularly for a branch or arm of the intersection, or for each road-segment that borders with the intersection or with the TLC. For example, Third Street east-bound has 7 vehicles, whose individual priority scores aggregate to 48; whereas, Third Street west-bound has 12 vehicles, whose individual priority scores aggregate to 72; whereas, Fifth Avenue north-bound has 6 vehicles, whose individual priority scores aggregate to 23; whereas, Fifth Avenue south-bound has 2 vehicles, whose individual priority scores aggregate to 7. In this example, the aggregate priority scores of traffic that approaches the TLC on Third Street from both directions (east and west) is 72+48=120 points; whereas, the aggregate priority scores of traffic that approaches the TLC on Fifth Avenue from both directions (north and south) is 23+7=30. Accordingly, the system operates to prolong or extend the time-slot allocated to green-light for Third Avenue traffic; and/to shorten or reduce the time-slot allocated to green-light for Fifth Avenue traffic. The modification may be by a pre-defined percentage value (e.g., increase or decrease the green-light time slot by K percent, such as, by 15 percent or by 20 percent or a baseline non-modified time-slot), or by a pre-defined time-period (e.g., by T seconds, by 5 seconds, by 8 seconds, or the like), or by a time-period that is a function of the difference in total priority points (e.g., 120−30=difference of 90 priority points; each 10 priority points of difference is converted into one additional second, or one additional percent, of green-light that is allocated to Third Street traffic). Other suitable modification mechanisms may be used.

Some embodiments may thus perform green-light distribution or allocation that is based on weighted priority scores of the various “arms” or “branches” or “phases” or road-segments that meet at the intersection or at the TLC. The allocation may also take into account pre-defined constraints or threshold values that must be adhered to; for example, a minimum time-length of a green-light (e.g., not less than Tmin consecutive seconds per road-segment, wherein Tmax is equal to 3 or 5 or 8 seconds, or other suitable value); a maximum time-length of a green-light (e.g., not more than Tmax consecutive seconds per road-segment, where Tmax is equal to 60 or 72 or 90 seconds, or other suitable value); a minimum time-length of a red-light; a maximum time-length of a red-light; a maximum or a minimum time-period between two consecutive green-lights (e.g., inter-green time-length); a maximum or a minimum time-period between two consecutive red-lights (e.g., inter-red time-length); constraints that reflect, or derive from, mandatory considerations or safety consideration (e.g., it takes at least K seconds to cross a particular large intersection), or constraints dictated by a local authority or municipality or traffic controlling authority; constraints that take into account a time-of-day parameter (e.g., rush hour traffic, morning commute traffic, evening commute traffic), a day-of-week parameter (e.g., weekend traffic), a date-related traffic (e.g., holiday rush traffic), event-based traffic (e.g., allocate longer green-lights to traffic outgoing from a rock concert that ended), weather-based information (e.g., allocate longer green-lights when the road is slippery or covered in snow), phase order requirement or definitions (e.g., the order in which phases or branches of the intersection receive their respective green-lights), minimum or maximum waiting time for pedestrians and/or for vehicles in a particular branch or arm of the intersection, minimum or maximum cycle time, and/or other suitable considerations or parameters.

In some embodiments, the distribution of green-light may be performed by taking into account a fusion of both (i) the one or more constraints described above, and also (ii) the weighted priority scores that were determined for each branch of the intersection or of the TLC.

In other embodiments, a two-stage process may be performed; for example, a first stage in which the above-mentioned constraints are firstly applied, yielding an excess or a remainder of green-light time-slot that can be distributed or allocated; and a second stage in which the remainder or excess green-light time-slot is allocated to a particular branch, or is divided or split or distributed to two or more branches (e.g., in an inequitable manner, and not necessarily equally among the branches). For example, a particular intersection or TLC may utilize a full-cycle time-period of 120 seconds; in the first stage, it is determined that 84 seconds are required in order to fulfill all the relevant constraints for that intersection, and that 36 seconds are the remainder of the green-light “budget” that can be further distributed to branches. That remainder, or excess, of 36 seconds of “green-light budget” may be distributed or allocated based on the weighted priority assigned to each branch.

In a first example, the vehicular traffic on Third Street has a cumulative weighted priority score of 60, and the vehicular traffic on Fifth Avenue has a cumulative weighted priority score of 40; and the excess green-light budget of 36 seconds is distributed among those two roads at a ratio of 60:40, namely, adding 60% of the 36 seconds (which is 21.6 seconds) to the green-light of the Third Street traffic, and adding 40% of the 36 seconds (which is 14.4 seconds) to the green-light of the Fifth Avenue traffic.

In a second example, the allocation of the excess green-light budget may be performed while taking into account constraints of its own, and/or by taking into account additional information regarding the utilization of at least a part of that excess green-light budget as it is being consumed and used. For example, if sensors or detectors dynamically sense that the allocation of the additional 21.6 seconds to the green-light of Third Street, does not suffice to alleviate the traffic on Third Avenue (e.g., 25 cars are still approaching the intersection on Third Street, whereas only 5 cars have exited the intersection on Third Street), then the remainder of the excess green-light budget (e.g., the 14.4 seconds portion) may be re-distributed among the branches or the phases based on a dynamically-updated or freshly-calculated weighted priority score for each branch or phase, or based on a pre-defined formula in order to achieve rapid convergence of calculations (e.g., divide the remainder of the not-yet-distributed excess green-light budget, according to a pre-defined ratio of 1:2, or 1:1, or 2:3, or according to the current ratio or the most-recent ratio of weighted priority scores of the branches involved).

In some embodiments, the weighted priority scores for each branch or phase of the intersection, may be dynamically updated and/or calculated every T seconds (e.g., every 1 second, or every 0.5 second, or every 1.75 seconds), thereby enabling the system to implement a dynamic and flexible approach that is based on real-time and up-to-date information. In other embodiments, additionally or alternatively, the weighted priority scores may be calculated or re-calculated at particular time-points or upon certain conditions; for example, upon completion of a cycle, or upon reaching one-half (or one-third, or N percent) of a full cycle length, or exactly T seconds before the next scheduled switch of green-light to red-light on Fifth Avenue, or the like.

Optionally, some embodiments may implement over-ruling or preemptive constraints that govern or that prevail over other type of calculations or decisions. For example, in one implementation, identification of an emergency vehicle (police car, ambulance, fire truck) that is approaching an intersection and is detected to be utilizing its emergency siren and/or its flashing emergency lights, may trigger the TLC system to immediately switch that road-segment to be receiving a green-light (while other road-segments receive red-lights), and/or to extend or prolong an already-active green-light of that particular arm or branch or phase of the intersection in which the emergency vehicle is progressing.

The system may utilize a variety of manners, local and/or remote data source and/or sensors and/or detectors in order to determine the data that is required for calculating the priority points for each vehicle and/or for calculating the weighted priority score for each lane and/or road-segment or arm or branch or phase of an intersection.

For example, in some embodiments, a smart vehicle is capable of detecting how many occupants are inside it, based on the number of buckled seat-belts, and/or based on weight sensors under the car seats, and/or based on an imager or camera within the vehicle that captures image(s) of the cabin and then performs image recognition or computer vision to detect the number of occupants; and the number of occupants may be transmitted by the vehicle to a nearby TLC, and/or to a remote server, using Wi-Fi, using cellular communication, using Vehicle to Infrastructure (V2I) communication, or the like.

In other embodiments, external imagers or cameras or other types of sensors may be located along the road, may capture image(s) of passing vehicles, and may utilize computer vision to perform a virtual “head count” of occupants in each vehicle. For example, Fifth Avenue traffic may run from north to south; a first camera is located at the eastern sidewalk of Fifth Avenue and is directed west-bound; a second camera is located across the avenue, at the western sidewalk of Fifth Avenue and is directed east-bound; each camera captures an image, which shows two occupants on each side, totaling four occupants inside the passing vehicle. Optionally, a computer vision module may correlate the two images, and may identify that a same person (e.g., using face recognition algorithms) appears in both images, thereby indicating that the same person was captured by both cameras from both sides of the vehicle such that the total number of occupants is corrected to only three and not four.

In other embodiments, a public transportation bus has 50 seats, and is actually occupied by 45 passengers; and 40 of them carry a smartphone. Each one of the 40 smartphones notifies a central transceiver or the bus (e.g., over Wi-Fi or a local W-LAN connection, or over a cellular connection) about its presence; and a central processor of the bus thus counts a total of 40 smartphones of passengers, and reports to the nearby TLC (or to a remote server, or to a remote TLC) over a wireless link that the approaching bus has (at least) 40 passengers plus one driver.

In other embodiments, each smartphone (e.g., of each occupant) may optionally include a pre-installed module or unit or “app” or mobile application, which may actively report to a remote server, or to a vehicular hub or processor, about the location and/or the presence of the smartphone; for example, over a cellular link; thereby allowing the system to determine the number of occupants per vehicle, optionally by giving to each occupant an incentive to install and run such application; for example, since the occupant knows that if he contributes to the system the information about his location, then his vehicle has better chances to be allocated a greater green-light period, and he will reach his destination earlier.

In other embodiments, each vehicle may similarly report to the TLC, and/or to a remote server, about its particular features or characteristics that are not necessarily its number of occupants. For example, an electric car may transmit (e.g., at pre-defined time intervals, every T seconds) a wireless signal or a message indicating to nearby infrastructure or TLC that this vehicle is an electric car. Similarly, a zero-emissions vehicle may transmit a wireless signal or message indicating so; a Consular vehicle may transmit a wireless signal or message indicating its identity as a Consular vehicle; or the like.

In other embodiments, a smart truck or a smart van may periodically transmit a wireless signal or message, indicating that it is carrying Hazardous Material; or indicating that it is carrying a particular type of cargo (e.g., animals, livestock) that is taken into account in the priority points grading. Additionally or alternatively, an imager within the truck or the van, and/or imager(s) located along the road, may capture images of the cargo; and a computer vision module may identify or deduce the type of cargo from those images, and a wireless transceiver or cellular transceiver may report the type of cargo to the nearby TLC and/or to a remote server, for the purpose of priority points determination.

For demonstrative purposes, some portions of the discussion above or herein relate to green-light and/or to red-light; however, the present invention may be utilized with a tri-light or tri-state TLC or intersection, having red-light and yellow-light and green-light, with similar conditions or criteria applied to such TLC or intersection.

Some embodiments of the present invention may operate in conjunction with light-less traffic signaling systems, in which a green-light or a red-light is not necessarily illuminated or displayed, but rather, a “go” or “stop” (or “no go”) signal is transmitted from the traffic signaling system to one or more vehicles or recipients (e.g., a vehicle, a self-driving vehicle, an autonomous vehicle) via a suitable communication means (e.g., wireless signal, Wi-Fi signal, V2I communication, or the like).

Some embodiments, of the present invention may operate in conjunction with a “traffic actuated time-plan”, in which the green-light that can be allocated to a particular direction or road or lane or phase of the interaction, is pre-defined as a time-length T in the range of T1 to T1+T2 (for example, in the range of 10 seconds to 30 seconds, or in the range of 10 seconds to 10+20 seconds); such that at least T1 seconds are allocated as a default minimum green-light length, whereas the additional T2 seconds vary between 0 to T2 based on the vehicular traffic that is approaching and/or waiting at that direction and/or in other directions. In some embodiments, T2 may be dynamically set to zero, for example, in a left-lane signal upon detection that the left lane does not have any vehicles waiting and/or approaching to turn left.

For demonstrative purposes, some sensors or detectors or modules that are described herein, may be described as connected to another unit or to a TLC via a wireless communication link; however, such sensors or detectors may utilize, additionally or alternatively, a wired link, a cable, fiber optic, copper wire, or the like. Similarly, some sensors or detectors or modules that are described herein, may be described as connected to another unit or to a TLC via a wired connection; however, such sensors or detectors may utilize, additionally or alternatively, a wireless communication link

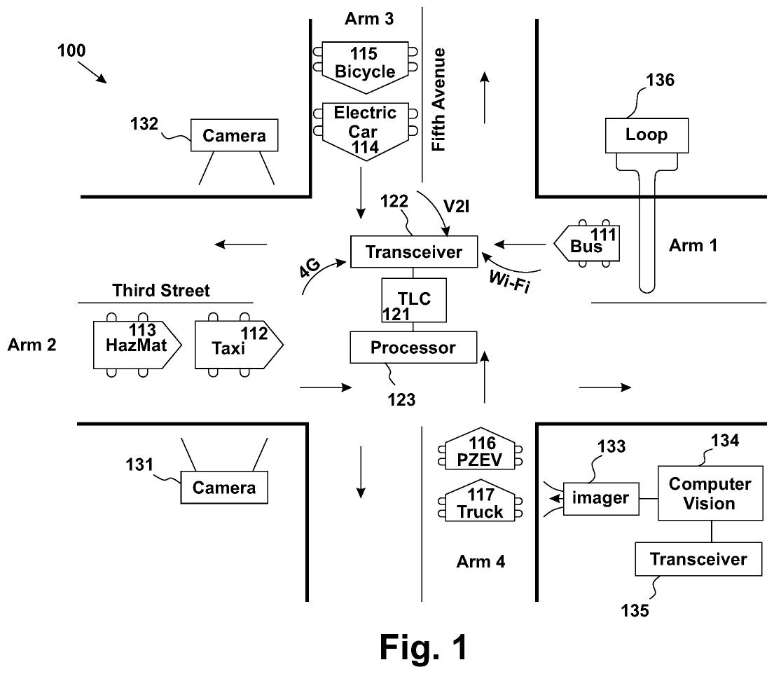

Reference is made to FIG. 1, which is a schematic illustration of a traffic system 100, in accordance with some demonstrative embodiments of the present invention. Traffic system 100 is demonstrated via a simple-form intersection of two roads, which are Third Street (running east to west, and west to east) and Fifth Avenue (running north to south, and south to north). To simplify the discussion herein, each Arm of the intersection (Arm 1, Arm 2, Arm 3, and Arm 4) has a single lane for through traffic and a single lane for opposite-direction traffic; and no turns are allowed in this simplified intersection.

A traffic light controller (TLC) 121 comprises traffic light units, that switch between two demonstrative states: (I) a first state, in which Third Street traffic gets green-light, while Fifth Avenue traffic gets red-light; and (II) a second state, in which Third Street traffic gets red-light, while Fifth Avenue traffic gets green-light. The TLC 121 is associated with a transceiver, able to receive wired signals and/or wireless signals from one or more sources or communication links; for example, from a wired link or cable, from a Wi-Fi wireless connection, from a cellular 4G connection, from a Vehicle to Infrastructure (V2I) communication link or channel, or the like. A processor 123 processes the data received by the transceiver 122, and regulates, controls, or modifies the operational settings of the TLC 121; and particularly, sets or modifies or shortens or extends the green-light time and/or the red-light time that is allocated to a particular road, or to a particular arm.

In Arm 1, a public transportation bus 111 is approaching the intersection, or is moving towards the intersection, or is stopped on its way to the intersection. Bus 111 notifies to the transceiver 122 of TLC 121 about the approaching or the position of bus 111, and/or about its identity as a public transportation bus; and the processor 123 allocates 5 priority points to bus 111 for being a public transportation bus. Optionally, bus 111 includes 50 seats, and 45 occupants, of which 40 occupants have smartphones that report their existence to a central vehicular module in bus 111; which in turn reports to transceiver 122 of TLC 123 that bus 111 carries at least 40 passengers plus one driver; and accordingly, processor 123 allocates 11 additional priority points to bus 111. The processor 123 sums the priority points for bus 111, which are 5+11=16. The processor 123 also sums the priority points for all the traffic in Arm 1, which is (in this example) only bus 111, and thus the total priority points for all the traffic in Arm 1 is also 16.

Optionally, a detector such as a loop detector 136 may be used, to detect the approaching of the bus 111 towards the intersection, and to determine or estimate its distance from the intersection, it speed, and/or its estimated time of arrival to the intersection; and such detector may transmit or transfer such data to the TLC 121 via the transceiver 122, or via a wired link or wired connection (electric cable, wire, fiber optic, copper wire, or the like).

In Arm 2, a taxi 112 is approaching the intersection. Taxi 112 notifies the TLC 121 over a cellular link that taxi 112 is indeed a taxi. Accordingly, processor 123 allocates to taxi 112, for example, 3 priority points for being a taxi. Additionally, a camera 131 and a camera 132 capture images of the taxi 112 from both sides; and a computer vision module receives the images (via a wire or cable, or wirelessly via a wireless transceiver) and identifies four occupants in the taxi. The processed data is transferred or transmitted to the TLC 121; and the processor 123 allocates to taxi 112, for example, 4 additional priority points for carrying three four occupants. The processor 123 sums the priority points for taxi 112, which are 3+4=7.

Still in Arm 2, a HazMat truck 113 is approaching, carrying hazardous material. The HazMat truck 113 may report its identity to the TLC 121, for example over a 3G cellular communication link; or, cameras 131 and/or 132 may capture an image of the HazMat truck 113, and a computer vision module identifies that this is a HazMat truck (e.g., based on identifying a HazMat license plate or warning sign on the vehicle). Accordingly, the processor 123 allocates to the HazMat truck 113, for example, 3 priority points for being a HazMat truck. The processor 123 sums the priority points for the HazMat truck, which are 3 priority points. The processor 123 may also sum the total priority points for all the vehicles of Arm 2, which are 7+3=10 priority points.

Meanwhile, in Arm 3, an electric car 114 approaches the intersection, and notifies its identity to the TLC 114 over a wireless communication link; and the processor 123 allocates to it 5 priority points for being an electric car, and 4 more priority points for carrying four occupants as reported to the TLC 114 by the electric car 114 which senses the number of occupants based on weight detectors and/or bucked-up seat-belts detectors; such that the electric car 114 is allocated a total of 9 priority points. Similarly, a bicycle 115 in Arm 3 is detected by a suitable sensor or detector (e.g., a loop detector; a camera or imager with computer vision module), and the data is transferred by such detector to the TLC 121, and the processor 123 allocates to the bicycle 115 a total of 3 priority points. The processor 123 also sums the total priority points of Arm 3, which are 9+3=12 priority points.

Similarly, in Arm 4 there are approaching a partially zero emissions vehicle (PZEV) 116, which identifies itself as such to the TLC 121 via a 4G-LTE communication link, and which is allocated 4.5 priority points for being a PZEV. Additionally, a truck 117 is in Arm 4, and an imager 133 capture its image(s), which are then processed by a computer vision module 134 that identifies that the truck carries livestock (animals being transported), the data is transmitted via a transceiver 135 to the TLC 121, and the processor 123 allocates 3.5 priority points to the truck 117. The processor 123 also sums the total priority points for Arm 4, which is 4.5+3.5=8 priority points. It is noted that other types of vehicles or road-users, such as, a snow plow vehicle, a garbage collection truck, a scooter, a bicycle, a pedestrian, or the like, may be allocated other suitable values of priority points.

The processor proceeds to analyze the priority points of each arm, and/or the priority points of each pair of arms of the same road. For example, Arm 1 has a total of 16 priority points; Arm 2 has a total of 10 priority points; and therefore the two arms of the road “Third Street” have a total of 16+10=26 priority points. Similarly, for example, Arm 3 has a total of 12 priority points; Arm 4 has a total of 8 priority points; and therefore the two arms of the road “Fifth Avenue” have a total of 12+8=20 priority points. The processor 123 may also calculate that the ratio of priority points of Third Street traffic to Fifth Avenue traffic is 26 to 20.

Based on these determinations, the processor 123 may modify the operational settings of the TLC 121, to extend the current green-light or the upcoming green-light of Third Street, by a pre-defied time-period of T seconds (e.g., 5 more seconds); or to distribute an excess green-light budget between Third Street and Fifth Avenue at a ratio of 26:20 which is their ratio of priority points; or based on other formula that takes into account the priority points of each arm and/or each road.

In another implementation, processor 123 may perform normalization or scale-conversion of the data; for example, may calculate the average priority points per car, or the average priority points per lane, or per phase (per direction), or per arm, or per road; and may utilize the averaged or normalized data as the basis for distributing the excess green-light budget.

For demonstrative purposes, some portions of the discussion above or herein relate to an intersection in which a first road (e.g., Third Street) allows traffic to move eastbound or westbound (and not south, and not north); whereas a second road (e.g., Fifth Avenue) allows traffic to move northbound or southbound (and not east, and not west). However, the present invention may be utilized with a more complex type of intersection, in which a particular road comprises: a first lane (or a first set of lanes) that allows traffic to move forward (“through traffic”), and a second lane (or a second set of lanes) that allows traffic to turn (e.g., a right-turn, or a left-turn, relative to the general direction of that particular road). Similarly, the present invention may be utilized with a more complex type of intersection, in which multiple roads or arms meet, and each arm of the intersection comprises a plurality of lanes, wherein some of the lanes are directed to move traffic only forward, some of the lanes are directed to move traffic only at a turn (right, or left), and some of the lanes are directed to move traffic either forward or at a turn.

In such intersection(s), optionally, an Averaging Module may be used, to determine an average priority score for the vehicles in each Lane, or in each Phase/Direction.

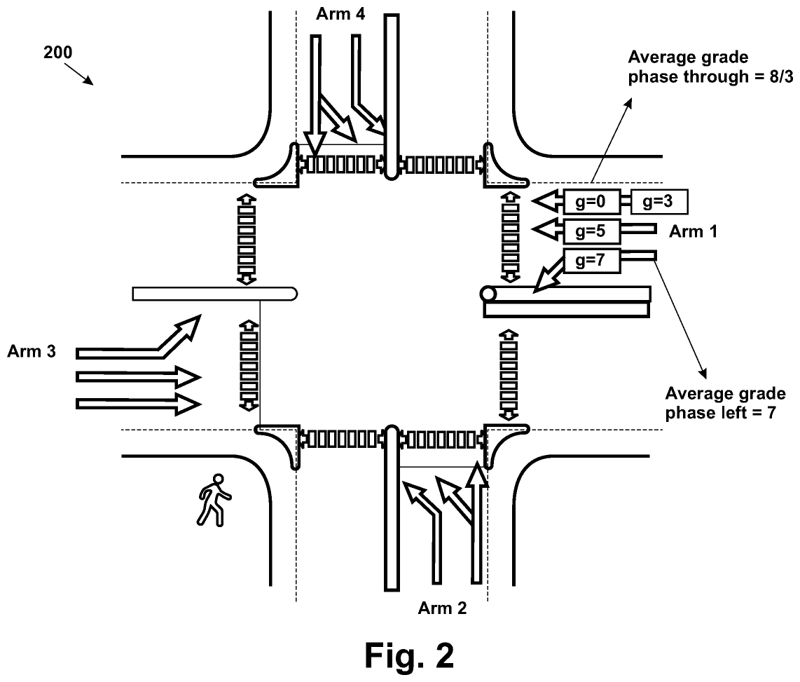

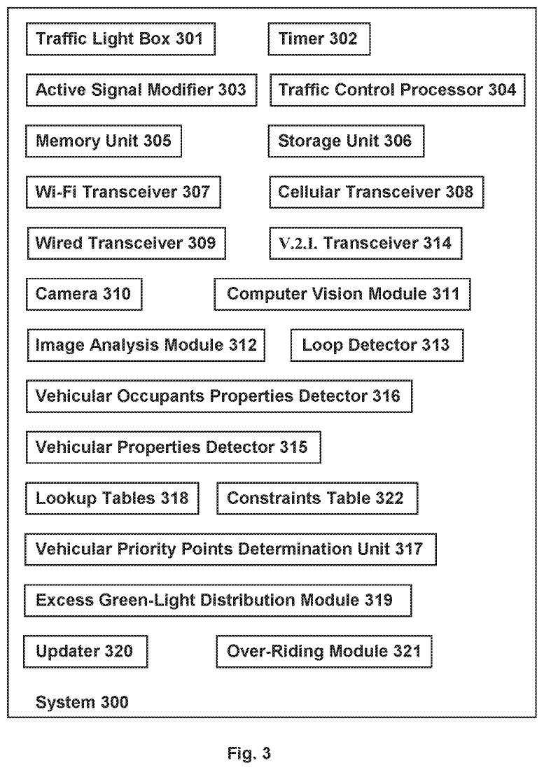

Reference is made to FIG. 2, which is a schematic illustration of another traffic system 200, in accordance with some demonstrative embodiments of the present invention. System 200 demonstrates distribution of green-light resources based on an average value of priority points, for example, per phase (per direction) in each one of the four Arms of the intersection.

For example, Arm 1 comprises three lanes: a first lane allows traffic to move only forward (“through traffic”), and has two vehicles, having priority points values of 0 and 3; a second lane allows traffic to move only forward, and has one vehicle, having priority points values of 5; and a third lane allows traffic to only turn left, and has one vehicle, having priority points of 7. The averaging module may sum the priority points of all the vehicles that are located in the first lane and the second lane, which are “through traffic” lanes, having 0+3+5=8 priority points in total for the “through traffic” phase, or having an average of 8/3 priority points per vehicle in that phase; whereas, the third lane has 7 priority points, or an average of 7/1 priority points per vehicle, at the “turn left” phase of that road.

Accordingly, in some embodiments, the allocation or distribution of green-light may take into account the total priority points per lane, and/or the total priority points per phase (or per direction), and/or the average priority points per lane, and/or the average priority points per phase (or per direction).

Some portions of the discussion may relate to vehicles, but the present invention may similarly apply to allocation of resources to other users of public spaces or roads or intersections, such as pedestrians, riders of bicycles or tricycles or scooters (e.g., motorized or non-motorized), and other users; and/or may apply to allocation of resources to vehicles by taking into account the pedestrians and/or such other users.

For example, a pedestrian may approach the interaction, and the system may be aware of this information by one or more ways; for example, the pedestrian may push a “cross the road” request button at or near the intersection, thereby notifying the TLC that a pedestrian desires to cross. Additionally or alternatively, a smartphone or smart-watch of the pedestrian may report to a remote server, or directly to the TLC, over a cellular link or a Wi-Fi link, that the pedestrian is approaching the intersection (e.g., based on a GPS or other location-finding mechanism of the end-user device; or based on the fact that the smartphone of the user is in the coverage area of a Wi-Fi network of the TLC; or the like).

Additionally or alternatively, a camera associated with the TLC or the intersection may capture images of the area and a computer vision/image analysis module may analyze the image and identify pedestrian(s) as well as their number and/or characteristics (e.g., identify that the pedestrian is a senior citizen that walks slowly, or a disabled person in a wheelchair, or a blind person having a sight-dog, or a young child who may be accompanied or non-accompanied by an adult, or a person pushing a baby stroller or a shopping cart, or the like).

The information about such pedestrian(s), their number, their exact location(s), and/or their particular characteristics, may be taken into account by the TLC or its processor for the purpose of distribution of green-light or red-light to vehicles and/or to pedestrians. For example, detection that there are currently zero pedestrians approaching the intersection and/or waiting to cross Fifth Avenue, may be used to support an increase of the green-light of vehicles that travel along Fifth Avenue, and/or to delay or to shorten the next green-light of pedestrians crossing Fifth Avenue. In another example, detecting that at least N pedestrians are approaching the intersection, and/or that at least M pedestrians are already waiting to cross the intersection, may support a shortening of the green-light for vehicles on Fifth Avenue, and/or may support a zero extension or a smaller extension of the green-light of vehicles on Fifth Avenue. In a third example, detection of particular type(s) of pedestrians, such as a disabled person or a blind person or a person pushing a baby stroller, may trigger the system to extend the time-period of the green-light allocated to pedestrians to cross the road. Other suitable conditions or criteria may be used.

Reference is made to FIG. 3, which is a schematic block-diagram illustration of a system 300, in accordance with some demonstrative embodiments of the present invention. System 300 comprises, for example, a Traffic Light Box 301, able to switch between two illuminated signals (e.g., green-light or red-light; or Go and Stop; or “walk” and “don't walk”), or able to switch among three illuminated signals having two or three colors (e.g., green, yellow, red), or able to toggle or switch various other signals or lights (e.g., a dedicated left-turn-only light or signal; a dedicated right-turn-only light or signal; or the like).

Traffic Light Box 301 may comprise or may include a Timer 302 or a real time clock (RTC) or similar unit able to measure the elapsing of time; and an Active Signal Modifier 303 able to turn-on and turn-off signals in order to ensure that only one particular light (or a particular subset of all lights) is turned-on or is turned-off. A Traffic Control Processor 304 is able to perform one or more of the calculations or determinations that are described above or herein; and may utilize a short-term memory unit 305 (e.g., RAM, or Flash memory) for short-term storage of data, as well as long-term storage unit 306 (e.g., hard disk drive (HDD), solid state drive (SDD), or the like) for long-term storage of data.

Storage unit 306 may store real-time data and/or historical data, that may be received from one or more sources and/or over one or more types of links; for example, utilizing a Wi-Fi Transceiver 307, a cellular transceiver 308, a wired transceiver 309 (e.g., connected to one or more wires or electric cables or optical-signal cables), or the like. Such means of communication may obtain, pull, or receive data from one or more detectors or sensors or sources; for example, from a camera 310 which may optionally be associated with a Computer Vision Module 311 and/or an Image Analysis Module 312 (e.g., able to identify a type of vehicle; able to detect the number or quantity or properties of vehicles and/or vehicular occupants and/or vehicular cargo); a loop detector 313 able to detect passage of a vehicle thereon; or the like.

The transceivers of the traffic control system may further be able to receive data transmitted directly, or indirectly (e.g., routed through a remote server or a communication node or a network element), from one or more vehicles and/or persons. For example, a Vehicle to Infrastructure (V2I) transceiver 314 may receive data from a smart-vehicle, indicating about properties of the vehicle and/or about properties of its occupants and/or cargo.

The system may further receive, pull or obtain data from one or more navigation systems, mapping systems, and/or route guidance systems, such as Google Maps, or Waze; which may report to the system that a particular road-segment currently has heavy traffic, or has a lane blocked due to a car accident, or other information that may be taken into account for allocating or distributing green-light resources among vehicles, pedestrians, and/or other users.

The system may thus utilize a Vehicular Properties Detector 315 able to determine one or more properties of each vehicle that approaches the intersection, by using camera, sensors, loop detectors, information obtained or transmitted from the vehicle itself, or the like. Similarly, a Vehicular Occupants Properties Detector 316 may determine insights about the occupants (and/or the cargo) of each approaching vehicle, for example, based on transmission from a smart-vehicle that is based on the number of buckled-up seat-belts or based on under-the-seat weight detectors, or based on cameras or imagers that capture images that are then analyzed to derive such insights about the occupants and/or the cargo.

A Vehicular Priority Points (PP) Determination Unit 317 determines or calculates the priority points for each such approaching vehicle, by utilizing the sensed data and/or the collected data and/or the received data, and by comparing or matching such data relative to one or more Lookup Tables 318 or pre-defined threshold values or ranges-of-values.

Optionally, an Averaging Module 318 may determine or may calculate the average or the mean value, or a weighted average or weighed score, or other statistical indicator, that corresponds to a subset of vehicles in a road or in a lane or in a phase (a direction of driving), or in a branch or arm of the intersection.

An excess green-light distribution module 319 may utilize the priority points that were determined for each vehicle and/or lane and/or phase (or direction of movement) and/or arm or branch of the intersection, based on a pre-defined formula or lookup table or function, to distribute or to allocate an additional green-light to a particular road or lane or phase or arm or branch of the intersection, and to determine the properties of such distribution (e.g., when exactly would the allocation occur and end). The traffic light box 301 may thus be controlled, and its operational settings may be modified, based on these generated insights or decisions.

An updater module 320 may periodically update determinations, for example, every 1 second or every 3 seconds or every T seconds, based on up-to-date data that was sensed or measured or received or collected from the multiple sources. Optionally, an over-riding module 321 may enforce pre-defined logic that dictates that a particular result prevails or governs, even if other calculations or determinations point towards a different result; for example, based on pre-defined Constraints Table 322, or based on pre-defined conditions or criteria which may be identified (e.g., emergency vehicle is approaching the intersection with emergency lights or siren).

Some embodiments of the invention may comprise or may utilize other suitable hardware units and/or software units.

For demonstrative purposes, portions of the discussion herein have demonstrated the present invention by referring to analysis of traffic approaching to (or located in) a single intersection; however, the present invention may similarly be used to control traffic resources in a coordinated manner across multiple intersections and/or multiple locations, such as, a set or series of adjacent or neighboring intersection, a traffic corridor or arterial, or the like. For example, multiple sensors, detectors and/or information sensors may report to a central processor, which analyzes data that pertains to multiple such intersection, and generates synchronized weighted priority decisions for the multiple intersections of that corridor or region.

In some embodiments, a method comprises: (a) receiving indications of characteristics of vehicles that are approaching to a particular intersection; (b) based on said characteristics, determining a priority score for each vehicle of said vehicles; (c) determining an aggregated priority score for each arm of said particular intersection; (d) based on the aggregated priority score determined in step (c) for each arm of said particular intersection, dynamically determining a green-light period to be allocated by a traffic light of said particular intersection, and commanding said traffic light to deploy said green-light period.

In some embodiments, the priority score for each vehicle is determined based on the number of occupants that is identified to be occupying said vehicle.

In some embodiments, the priority score for each vehicle is determined based on the type of occupants that is identified to be occupying said vehicle.

In some embodiments, the priority score for each vehicle is determined based on the type of occupants that is identified to be occupying said vehicle; wherein said type of occupants is identified to be: school students transported in a school-bus.

In some embodiments, the priority score for each vehicle is determined based on the type of occupants that is identified to be occupying said vehicle; wherein said type of occupants is identified to be: occupants of an ambulance.

In some embodiments, the priority score for each vehicle is determined based on a type of cargo that is transported by said vehicle.

In some embodiments, the priority score for each vehicle is determined based on a type of cargo that is transported by said vehicle; wherein said type of cargo is identified to be: Hazardous Material (Haz-Mat) cargo.

In some embodiments, the priority score for each vehicle is determined based on the type of energy that is consumed by said vehicle.

In some embodiments, the priority score for each vehicle is determined based on the type of energy that powers said vehicle; wherein the type of energy is identified to be: electric energy; wherein a determination that a particular vehicle is powered by electric energy triggers an increase in the priority score for said particular vehicle as an incentive to electric-power vehicles.

In some embodiments, the priority score for each vehicle is determined based on the type of energy that powers said vehicle; wherein the type of energy is identified to be: gasoline-based energy; wherein a determination that a particular vehicle is powered by gasoline-based energy triggers an increase in the priority score for said particular vehicle in order to enable rapid removal of said particular vehicle from said particular intersection.

In some embodiments, step (a) comprises: determining the characteristics of said vehicles by (i) capturing images of said vehicles approaching said particular intersection, and (ii) performing image analysis of said images to extract from them vehicular characteristics.

In some embodiments, step (a) comprises: determining the characteristics of said vehicles by (i) capturing images of said vehicles approaching said particular intersection, and (ii) performing image analysis of said images, wherein said image analysis comprises at least counting the number of occupants in each of said vehicles.

In some embodiments, step (a) comprises: determining the characteristics of said vehicles by (i) capturing images of said vehicles approaching said particular intersection, and (ii) performing image analysis of said images, wherein said image analysis comprises at least performing Optical Character Recognition (OCR) analysis of a label that appears on at least one of said vehicles to determine vehicular type or vehicular characteristics.

In some embodiments, step (a) comprises: determining the characteristics of at least one particular vehicle, based on a wireless communication signal that is received from said particular vehicle and which indicates the vehicular type of said vehicle.

In some embodiments, step (a) comprises: determining the characteristics of at least one particular vehicle, based on a wireless communication signal that is received from said particular vehicle and which indicates the vehicular type of said vehicle; wherein said wireless communication signal is received at said traffic light directly from said vehicle via a direct Vehicle-to-Infrastructure wireless communication link

In some embodiments, step (a) comprises: determining the characteristics of at least one particular vehicle, based on a wireless communication signal that is received from said particular vehicle and which indicates the vehicular type of said vehicle; wherein said wireless communication signal is received at a remote server, that is located away from said traffic light, and which determines the priority score for said particular vehicle, and which transmits the priority score to the traffic light.

In some embodiments, step (a) comprises: determining the characteristics of at least one particular vehicle, based on a wireless communication signal that is received from said particular vehicle and which indicates the current number of occupants of said vehicle.

In some embodiments, step (a) comprises: determining the characteristics of at least one particular vehicle, based on a wireless communication signal that is received from said particular vehicle and which indicates the current number of occupants of said vehicle; wherein said wireless communication signal is received at said traffic light directly from said vehicle via a direct Vehicle-to-Infrastructure wireless communication link

In some embodiments, step (a) comprises: determining the characteristics of at least one particular vehicle, based on a wireless communication signal that is received from said particular vehicle and which indicates the current number of occupants of said vehicle; wherein said wireless communication signal is received at a remote server, that is located away from said traffic light, and which determines the priority score for said particular vehicle, and which transmits the priority score to the traffic light.

In some embodiments, step (a) comprises: determining the characteristics of at least one particular vehicle, based on a wireless communication signal that is received from said particular vehicle and which indicates the type of cargo that is currently transported in said vehicle.

In some embodiments, step (a) comprises: determining the characteristics of at least one particular vehicle, based on a wireless communication signal that is received from said particular vehicle and which indicates the type of cargo that is currently transported in said vehicle; wherein said wireless communication signal is received at said traffic light directly from said vehicle via a direct Vehicle-to-Infrastructure wireless communication link

In some embodiments, step (a) comprises: determining the characteristics of at least one particular vehicle, based on a wireless communication signal that is received from said particular vehicle and which indicates the type of cargo that is currently transported in said vehicle; wherein said wireless communication signal is received at a remote server, that is located away from said traffic light, and which determines the priority score for said particular vehicle, and which transmits the priority score to the traffic light.

In some embodiments, step (a) comprises: determining the characteristics of at least one particular vehicle, based on a wireless communication signal that is received from said particular vehicle and which indicates the type of occupants that are currently transported in said vehicle.

In some embodiments, step (a) comprises: determining the characteristics of at least one particular vehicle, based on a wireless communication signal that is received from said particular vehicle and which indicates the type of occupants that are currently transported in said vehicle; wherein said wireless communication signal is received at said traffic light directly from said vehicle via a direct Vehicle-to-Infrastructure wireless communication link

In some embodiments, step (a) comprises: determining the characteristics of at least one particular vehicle, based on a wireless communication signal that is received from said particular vehicle and which indicates the type of occupants that are currently transported in said vehicle; wherein said wireless communication signal is received at a remote server, that is located away from said traffic light, and which determines the priority score for said particular vehicle, and which transmits the priority score to the traffic light.

In some embodiments, step (a) comprises: determining the characteristics of at least one particular vehicle, based on a wireless communication signal that is received from said particular vehicle and which indicates the number of current occupants in said vehicle as determined based at least on seat weight-sensors located under seats within said particular vehicle.

In some embodiments, step (a) comprises: determining the characteristics of at least one particular vehicle, based on a wireless communication signal that is received from said particular vehicle and which indicates the number of current occupants in said vehicle as determined based at least on closure status of seat-belts that are located within said particular vehicle.

In some embodiments, step (d) comprises: based on the aggregated priority score determined in step (c) for each arm of said particular intersection, dynamically extending by N seconds the green-light period of a particular arm of said particular intersection; wherein N is a positive number.

In some embodiments, step (d) comprises: based on the aggregated priority score determined in step (c) for each arm of said particular intersection, dynamically extending by N percent the green-light period of a particular arm of said particular intersection; wherein N is a positive number.

In some embodiments, step (d) comprises: based on the aggregated priority score determined in step (c) for each arm of said particular intersection, determining to change at least one arm of said particular intersection from having a green-light to having an orange-light and then a red-light, and commanding said traffic light to perform said change.

In some embodiments, the method receives data about vehicles approaching multiple intersections, and determines the green-light allocation of a particular intersection based on said data about vehicles approaching to multiple intersections.

Some embodiments comprise a non-transitory storage medium having stored thereon instructions, that when executed by a machine, cause said machine to perform a method as described above.

Some embodiments comprise a traffic light controller (TLC), comprising a processor to execute code which causes said traffic light controller to perform the operations of a method as described above. In some embodiments, the traffic light controller is co-located with said traffic light at said particular intersection. In other embodiments, the traffic light controller is located away from said traffic light and away from said particular intersection, and transmits information and commands to said traffic light via a communication link

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

The present invention may be implemented by using hardware units, software units, processors, CPUs, DSPs, a Programmable Logic Controller (PLC), integrated circuits, memory units, storage units, wireless communication modems or transmitters or receivers or transceivers, cellular transceivers, a power source, input units, output units, Operating System (OS), drivers, applications, and/or other suitable components.

The present invention may be implemented by using a special-purpose machine or a specific-purpose that is not a generic computer, or by using a non-generic computer or a non-general computer or machine. Such system or device may utilize or may comprise one or more units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

The present invention may be implemented by using code or program code or machine-readable instructions or machine-readable code, which is stored on a non-transitory storage medium or non-transitory storage article (e.g., a CD-ROM, a DVD, a solid state drive (SSD), a portable memory unit, SD Card, portable Flash drive, Disk On Key, or the like), a physical memory unit, a physical storage unit), such that the program or code or instructions, when executed by a processor or a machine or a computer, cause such device to perform a method in accordance with the present invention.

Embodiments of the present invention may be utilized with a variety of devices or systems having a touch-screen or a touch-sensitive surface; for example, a smartphone, a cellular phone, a mobile phone, a smart-watch, a tablet, a handheld device, a portable electronic device, a portable gaming device, a portable audio/video player, an Augmented Reality (AR) device or headset or gear, a Virtual Reality (VR) device or headset or gear, a “kiosk” type device, a vending machine, an Automatic Teller Machine (ATM), a laptop computer, a desktop computer, a vehicular computer, a vehicular dashboard, a vehicular touch-screen, or the like.

The system(s) and/or device(s) of the present invention may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or devices of the present invention may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with embodiments of the present invention, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL, BASIC, Visual BASIC, Matlab, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a list of reference value(s) or a database of reference values or ranges; a comparison or matching or searching process which searches for matches and/or identical results and/or similar results and/or sufficiently-close results, among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner

Some embodiments may comprise, or may be implemented by using, an “app” or application which may be downloaded or obtained from an “app store” or “applications store”, for free or for a fee, or which may be pre-installed on a computing device or electronic device, or which may be transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings, or even if they are depicted in any drawing(s) without necessarily being connected via a line or an arrow.

While certain features of the present invention have been illustrated and described herein, many modifications, substitutions, changes, and equivalents may occur to those skilled in the art. Accordingly, the claims are intended to cover all such modifications, substitutions, changes, and equivalents.

1. A method comprising:
(a) receiving indications of characteristics of vehicles that are approaching to a particular intersection;
(b) based on said characteristics, determining a priority score for each vehicle of said vehicles;
(c) determining an aggregated priority score for each arm of said particular intersection;
(d) based on the aggregated priority score determined in step (c) for each arm of said particular intersection, dynamically determining a green-light period to be allocated by a traffic light of said particular intersection, and commanding said traffic light to deploy said green-light period.

2. The method according to claim 1,
wherein the priority score for each vehicle is determined based on the number of occupants that is identified to be occupying said vehicle.

3. The method according to claim 1,
wherein the priority score for each vehicle is determined based on the type of occupants that is identified to be occupying said vehicle.

4. The method according to claim 1,
wherein the priority score for each vehicle is determined based on the type of occupants that is identified to be occupying said vehicle;
wherein said type of occupants is identified to be: school students transported in a school-bus.

5. The method according to claim 1,
wherein the priority score for each vehicle is determined based on the type of occupants that is identified to be occupying said vehicle;
wherein said type of occupants is identified to be: occupants of an ambulance.

6. The method according to claim 1,
wherein the priority score for each vehicle is determined based on a type of cargo that is transported by said vehicle.

7. The method according to claim 1,
wherein the priority score for each vehicle is determined based on a type of cargo that is transported by said vehicle;
wherein said type of cargo is identified to be: Hazardous Material (Haz-Mat) cargo.

8. The method according to claim 1,
wherein the priority score for each vehicle is determined based on the type of energy that is consumed by said vehicle.

9. The method according to claim 1,
wherein the priority score for each vehicle is determined based on the type of energy that powers said vehicle;
wherein the type of energy is identified to be: electric energy;
wherein a determination that a particular vehicle is powered by electric energy triggers an increase in the priority score for said particular vehicle as an incentive to electric-power vehicles.

10. The method according to claim 1,
wherein the priority score for each vehicle is determined based on the type of energy that powers said vehicle;
wherein the type of energy is identified to be: gasoline-based energy;
wherein a determination that a particular vehicle is powered by gasoline-based energy triggers an increase in the priority score for said particular vehicle in order to enable rapid removal of said particular vehicle from said particular intersection.

11. The method according to claim 1,
wherein step (a) comprises:
determining the characteristics of said vehicles by (i) capturing images of said vehicles approaching said particular intersection, and (ii) performing image analysis of said images to extract from them vehicular characteristics.

12. The method according to claim 1,
wherein step (a) comprises:
determining the characteristics of said vehicles by (i) capturing images of said vehicles approaching said particular intersection, and (ii) performing image analysis of said images, wherein said image analysis comprises at least counting the number of occupants in each of said vehicles.

13. The method according to claim 1,
wherein step (a) comprises:
determining the characteristics of said vehicles by (i) capturing images of said vehicles approaching said particular intersection, and (ii) performing image analysis of said images, wherein said image analysis comprises at least performing Optical Character Recognition (OCR) analysis of a label that appears on at least one of said vehicles to determine vehicular type or vehicular characteristics.

14. The method according to claim 1,
wherein step (a) comprises:
determining the characteristics of at least one particular vehicle, based on a wireless communication signal that is received from said particular vehicle and which indicates the vehicular type of said vehicle.

15. The method according to claim 1,
wherein step (a) comprises:
determining the characteristics of at least one particular vehicle, based on a wireless communication signal that is received from said particular vehicle and which indicates the vehicular type of said vehicle;
wherein said wireless communication signal is received at said traffic light directly from said vehicle via a direct Vehicle-to-Infrastructure wireless communication link.

16. The method according to claim 1,
wherein step (a) comprises:
determining the characteristics of at least one particular vehicle, based on a wireless communication signal that is received from said particular vehicle and which indicates the vehicular type of said vehicle;
wherein said wireless communication signal is received at a remote server, that is located away from said traffic light, and which determines the priority score for said particular vehicle, and which transmits the priority score to the traffic light.

17. The method according to claim 1,
wherein step (a) comprises:
determining the characteristics of at least one particular vehicle, based on a wireless communication signal that is received from said particular vehicle and which indicates the current number of occupants of said vehicle.

18. The method according to claim 1,
wherein step (a) comprises:
determining the characteristics of at least one particular vehicle, based on a wireless communication signal that is received from said particular vehicle and which indicates the current number of occupants of said vehicle;
wherein said wireless communication signal is received at said traffic light directly from said vehicle via a direct Vehicle-to-Infrastructure wireless communication link.

19. The method according to claim 1,
wherein step (a) comprises:
determining the characteristics of at least one particular vehicle, based on a wireless communication signal that is received from said particular vehicle and which indicates the current number of occupants of said vehicle;
wherein said wireless communication signal is received at a remote server, that is located away from said traffic light, and which determines the priority score for said particular vehicle, and which transmits the priority score to the traffic light.

20. The method according to claim 1,
wherein step (a) comprises:
determining the characteristics of at least one particular vehicle, based on a wireless communication signal that is received from said particular vehicle and which indicates the type of cargo that is currently transported in said vehicle.

21. The method according to claim 1,
wherein step (a) comprises:
determining the characteristics of at least one particular vehicle, based on a wireless communication signal that is received from said particular vehicle and which indicates the type of cargo that is currently transported in said vehicle;
wherein said wireless communication signal is received at said traffic light directly from said vehicle via a direct Vehicle-to-Infrastructure wireless communication link.

22. The method according to claim 1,
wherein step (a) comprises:
determining the characteristics of at least one particular vehicle, based on a wireless communication signal that is received from said particular vehicle and which indicates the type of cargo that is currently transported in said vehicle;
wherein said wireless communication signal is received at a remote server, that is located away from said traffic light, and which determines the priority score for said particular vehicle, and which transmits the priority score to the traffic light.

23. The method according to claim 1,
wherein step (a) comprises:
determining the characteristics of at least one particular vehicle, based on a wireless communication signal that is received from said particular vehicle and which indicates the type of occupants that are currently transported in said vehicle.

24. The method according to claim 1,
wherein step (a) comprises:
determining the characteristics of at least one particular vehicle, based on a wireless communication signal that is received from said particular vehicle and which indicates the type of occupants that are currently transported in said vehicle;
wherein said wireless communication signal is received at said traffic light directly from said vehicle via a direct Vehicle-to-Infrastructure wireless communication link.

25. The method according to claim 1,
wherein step (a) comprises:
determining the characteristics of at least one particular vehicle, based on a wireless communication signal that is received from said particular vehicle and which indicates the type of occupants that are currently transported in said vehicle;
wherein said wireless communication signal is received at a remote server, that is located away from said traffic light, and which determines the priority score for said particular vehicle, and which transmits the priority score to the traffic light.

26. The method according to claim 1,
wherein step (a) comprises:
determining the characteristics of at least one particular vehicle, based on a wireless communication signal that is received from said particular vehicle and which indicates the number of current occupants in said vehicle as determined based at least on seat weight-sensors located under seats within said particular vehicle.

27. The method according to claim 1,
wherein step (a) comprises:
determining the characteristics of at least one particular vehicle, based on a wireless communication signal that is received from said particular vehicle and which indicates the number of current occupants in said vehicle as determined based at least on closure status of seat-belts that are located within said particular vehicle.

28. The method according to claim 1,
wherein step (d) comprises:
based on the aggregated priority score determined in step (c) for each arm of said particular intersection, dynamically extending by N seconds the green-light period of a particular arm of said particular intersection; wherein N is a positive number.

29. The method according to claim 1,
wherein step (d) comprises:
based on the aggregated priority score determined in step (c) for each arm of said particular intersection, dynamically extending by N percent the green-light period of a particular arm of said particular intersection; wherein N is a positive number.

30. The method according to claim 1,
wherein step (d) comprises:
based on the aggregated priority score determined in step (c) for each arm of said particular intersection, determining to change at least one arm of said particular intersection from having a green-light to having an orange-light and then a red-light, and commanding said traffic light to perform said change.

31. The method according to claim 1,
wherein the method receives data about vehicles approaching multiple intersections, and determines the green-light allocation of a particular intersection based on said data about vehicles approaching to multiple intersections.

32. A non-transitory storage medium having stored thereon instructions, that when executed by a machine, cause said machine to perform a method comprising:
(a) receiving indications of characteristics of vehicles that are approaching to a particular intersection;
(b) based on said characteristics, determining a priority score for each vehicle of said vehicles;
(c) determining an aggregated priority score for each arm of said particular intersection;
(d) based on the aggregated priority score determined in step (c) for each arm of said particular intersection, dynamically determining a green-light period to be allocated by a traffic light of said particular intersection, and commanding said traffic light to deploy said green-light period.

33. A traffic light controller, comprising:
a processor to execute code which causes said traffic light controller to perform:
(a) receiving indications of characteristics of vehicles that are approaching to a particular intersection;
(b) based on said characteristics, determining a priority score for each vehicle of said vehicles;
(c) determining an aggregated priority score for each arm of said particular intersection;
(d) based on the aggregated priority score determined in step (c) for each arm of said particular intersection, dynamically determining a green-light period to be allocated by a traffic light of said particular intersection, and commanding said traffic light to deploy said green-light period.

34. The traffic light controller of claim 33,
wherein the traffic light controller is co-located with said traffic light at said particular intersection.

35. The traffic light controller of claim 33,
wherein the traffic light controller is located away from said traffic light and away from said particular intersection, and transmits information and commands to said traffic light via a communication link.
